(19) United States
(12) Patent Application Publication
(10) Pub. No.: US 2007/0109126 A1
(43) Pub. Date: May 17, 2007

(54) METHOD FOR RECOVERING AND/OR REPATRIATING LOST ITEMS

(76) Inventor: Bessie House, Beachwood, OH (US)

Correspondence Address: STANDLEY LAW GROUP LLP, 495 METRO PLACE SOUTH, SUITE 210, DUBLIN, OH, 43017, US

(21) Appl. No.: 11/469,529

(22) Filed: Sep. 1, 2006

Related U.S. Application Data
(60) Provisional application No. 60/596,153, filed on Sep. 2, 2005.

(51) Int. Cl. G08B 13/14; G06F 17/00; G08B 23/00

(52) U.S. Cl. 340/572.1; 340/573.1; 235/375

(57) ABSTRACT

Repatriation of an item of lost personal property with the owner is achieved with an arrangement that closely associates a transponder with the personal property item. The transponder emits a unique identifying signal when stimulated by an excitation signal from a detection unit. A database is compiled and maintained by a service provider. The databases contains a population of records, each record associating the unique identifying signal from one of the transponders with identifying information of the owner. When a finder of the item contacts the service provider, a conduit through which the item can be returned to the owner is established.

### CROSS-REFERENCE TO RELATED APPLICATIONS

This application is a non-provisional of U.S. provisional patent application 60/596,153, filed 2 Sep. 2005, which is incorporated by reference as if fully recited herein.

### TECHNICAL FIELD

The present invention relates to a method for locating commonly-used items, particularly small items such as keys, eyeglasses and the like. In situations where the item has not strayed far from the owner, the method involves a signal to the owner from a transponder intimately associated with the device. In other situations where the item has been truly lost, a visually discernable tag or indicium on the device will identify the owner of the item as being affiliated with a particular service provider. The service provider maintains a database of item information that can establish a conduit for repatriation of the item with the owner.

### BACKGROUND OF THE ART

The average person carries around a number of items of relatively small size but proportionately large value, the loss of any of which can cause at least consternation. In many situations, however, the loss of the property can cause large financial loss to the owner, particularly when the item is directly identifiable to the owner.

One example of such an item is a set of car, house or office keys. Since the keys are frequently used when the user is handling other objects, they are easily mislaid. If a person of low character comes into possession of the keys, the potential for loss is great. In many cases, the probability of loss is low, as the keys are mislaid within a relatively well-controlled zone of influence of the user, such as actually in the house or office. For such a situation, a first mode for discovering the lost item is appropriate. In other cases, the keys or other items are lost in a public area, or at least an area not close, to or controlled by, the user. In these cases, the user will be unlikely to be repatriated with the lost item, unless a mode for discovering and repatriating the item to the user is provided. In the past, a simple and effective repatriation mode would have been to place an identification tag with the owner's name, address and/or telephone number. If found, the lost item was easily and reliably (usually) returned to its proper owner.

Unfortunately, the increasing incidence of identity theft, and the risk of a large loss in such a theft, has made certain items attractive as targets for theft, such as personal data assistants (“PDAs”), portable computers, mobile telephones, luggage, etc. These items may well have more value for the personal information they contain than for their inherent value.

As a result, people are becoming increasingly reluctant to place visually perceptible identification indicia, such as name tags on these items, ignoring the clear fact that the lack of such a name tag decreases the possibility of having the item repatriated.

It is therefore an unmet advantage of the prior art to provide a reliable means for repatriating a found item with its owner without placing a visually discernable identification indicium of the owner on the object.

### SUMMARY OF THE INVENTION

This and other advantages are provided by an arrangement for repatriating an item of found personal property with its owner. In a most basic embodiment, the arrangement has a transponder that is closely associated with the personal property item. The transponder, when stimulated by an excitation signal, emits a unique identifying signal. A database, also part of the arrangement, comprises a population of records, with each record in the database associating the unique identifying signal from one of the transponders with certain identifying information of the owner of the personal property item associated with the transponder. This database is maintained by a service provider. In this arrangement, a finder of a lost item can contact the service provider, through whom a conduit from the finder to the owner of the item is established, resulting in repatriation of the item with the owner.

In many embodiments, the transponder is a radio frequency identification (“RFID”) transponder. It may be a transponder that is internally contained within the personal property item or is affixed externally to the personal property item.

In some embodiments, the transponder has been installed or embedded in the item when the item was manufactured, while in other embodiments, the transponder was installed in the item or otherwise closely associated with the item once the item was in the possession and ownership of the owner.

In some embodiments, a visibly discernable indicium is closely associated with the personal property item. The indicium identifies the item as having an affiliation with the service provider.

Recognizing that the item of personal property may be locally misplaced by the owner, some embodiments may further include a means for emitting an appropriate excitation signal and receiving the unique identifying signal from any transponder located proximately thereto. This device, provided to the owner, allows the owner to directly locate misplaced items without involving the service provider.

Certain other advantages are achieved through a method for repatriating an item of lost personal property with it owner. The method has a step of associating at least one item of the owner's personal property with the owner by establishing a one-to-one relationship between the owner and a unique identifying signal emitted by the personal property item when a transponder associated with the item is stimulated by an excitation signal. This may be achieved through various substeps. Then, a database is compiled and maintained, the database having a population of records, each record associating the unique identifying signal from one of the transponders with owner-identifying information for the personal property item associated with the transponder. The method also has the step of providing at least one means through which a finder of the lost item can establish a conduit for the return of the item to its owner.

In some of these methods, the associating step comprises the substep of identifying the unique identifying signal of the transponder, which is internally contained within the personal property item with the owner. In other of the methods, the associating step comprises the substep of associating the unique identifying signal with the item by affixing the transponder to the item. In some of the methods, the associating step further comprises the substep of affixing a visibly discernable indicium on the personal property item, the indicium identifying an affiliation with the service provider.

The some embodiments of the method, the service providing step comprises the steps of receiving information about the unique identifying signal from the signal, and repatriating the item with the owner when the owner is identifiable. In some of these embodiments, the repatriating step includes the step of paying an appropriate reward to the finder.

### BRIEF DESCRIPTION OF THE DRAWINGS

Certain novel features and advantages, in addition to those mentioned above, will be better understood by those skilled in the art from a reading of the following detailed description in conjunction with the accompanying drawings wherein identical reference characters refer to identical parts and in which:

FIG. 1 is a perspective view of a first embodiment of the present invention;

FIG. 2 is a perspective view of a second embodiment;

FIG. 3 is a perspective view of a third embodiment; and

FIG. 4 is a flow diagram of an exemplary embodiment of a method of the invention.

### DETAILED DESCRIPTION OF A PREFERRED EMBODIMENT

As a first illustrative embodiment, a situation is described involving a set of keys. It will be easily recognized that the specific object is not a critical part of the invention and that the arrangement described may be successfully applied to a large number of other objects. While the apparatus and method can, in general, be applied to almost all tangible personal property, very elementary economics will indicate that the arrangement and method will be applied to a much more limited scope of items.

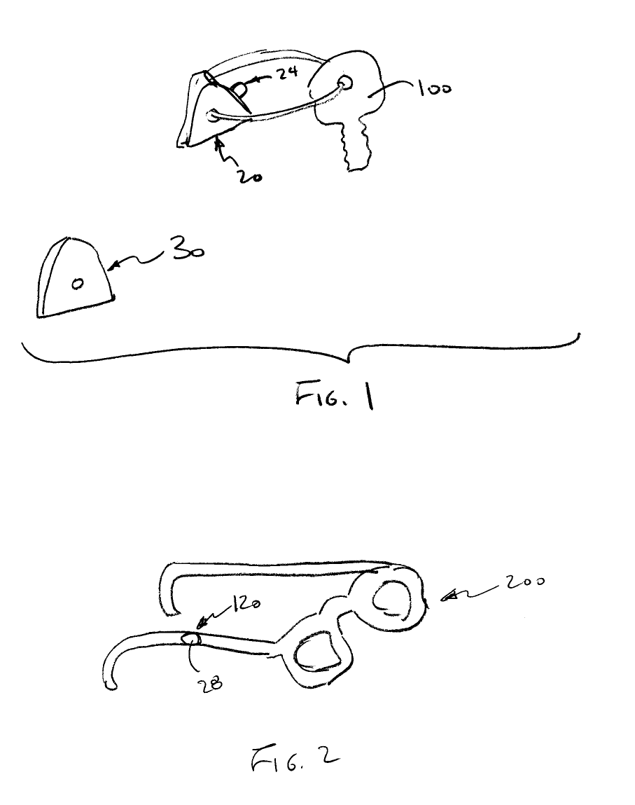

Directing attention to FIG. 1, the arrangement has two distinct parts. The first part is a receiver device 20 that is attached to or otherwise intimately associated with the object 100, illustrated in FIG. 1 as a set of keys. The second part of the apparatus is a transmitter device 30. The general operation of the transmitter 30 and receiver 20, in this first mode, are well-known and will be in possession of one of ordinary skill. When the personal property item 100 associated with the receiver 20 is determined to be misplaced, the user of the arrangement, typically the owner, will use the transmitter 30 for locating the misplaced object. The transmitter 30 will not normally be attached to or intimately associated with the object 100 or the receiver 20. By taking the transmitter 30 to an area where the lost object 100 is believed to be, the user can activate a means for transmitting a signal, contained in the transmitter. In some embodiments, this transmitting means can be a radio frequency transmitter. In other embodiments, it can be an infra-red transmitter. In any case, the transmitted signal will be a low power signal that should have a range of perhaps up to 50 feet. If the lost item 100 is within range of the transmitted signal, a receiving means (not shown in FIG. 1) in the receiver 20 will send a signal to an acknowledgement device 24 built into receiver 20. In one embodiment, the acknowledgement device will be an LED that will emit a light signal upon receiving a signal from the receiving means. In another embodiment, the acknowledgement device will be an auditory emitter, and will emit a “chirp” or “beep” upon receiving a signal from the receiving means.

Current transmitter and receiver technology is of a state that the energy requirement for receiving the low power signal from the transmitter 30 and causing the acknowledgement device 24 to respond is sufficiently high that the receiver 20 will need to have a portable power source, such as a battery, installed in the receiver. In this first embodiment, the item being intimately associated with the receiver 20 is a set of keys 100, so the receiver can be large enough and conspicuous enough to easily contain a power source, such as a disc-type battery.

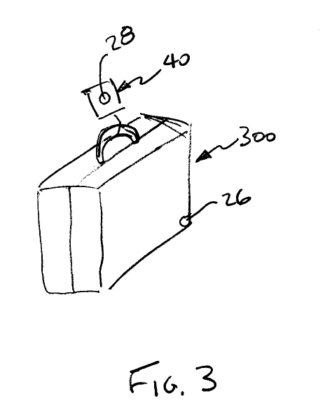

Further aspects of another embodiment are disclosed in FIG. 2. This aspect operates with the receiver 120 alone, that is, in isolation from the transmitter 30, at least in isolation from the type of transmitter that would be sold with the receiver. This aspect of the invention will usually comprise two components: a chip-like transponder (not seen in FIG. 2) built into the receiver 120 and a distinctive marking feature, preferably one that is incorporated into a body or housing of the receiver. In this case, the distinctive marking feature is a visibly discernable indicium 28, such as a conspicuously colored portion of a temple piece of a pair of eyeglasses 200. This second aspect of the present invention comes into use when the personal property item 200 (shown in this case as a pair of eyeglasses), with which the receiver 120 is associated, is lost, that is, it is beyond the range of the user possessing the transmitter 30. In such a situation, no amount of use of the transmitter 30 by the owner will result in eliciting a responsive signal from the acknowledgement device.

When this degree of physical separation of the item 200 from its owner occurs, it is the presence of at least one two features that will enable repatriation of the item with its owner: the transponder 26 and the visibly discernable indicium 28. In a particular application of an emerging technology, the transponder 26 will be a radio frequency identification (“RFID”) transponder. Such an RFID transponder, upon stimulation by an incoming excitation signal, emits a unique identifying signal, which is most commonly a digital numeric identifier.

Because of its small size, the transponder 26 may be embedded or otherwise directly incorporated into the device. For example, a fine piece of jewelry, such as a watch, may have an identifying transponder 26 installed upon manufacture as a part of the standard manufacture process, in lieu of (or possibly in addition to) an identifying serial number. In that manner, the transponder 26, or more particularly, the unique identifying signal emitted thereby, operates as an identifier of the model, year of manufacture, place of manufacture, etc., which may be useful in some instances for warranty purposes and, in other instances, for product tracking purposes. In any case, the manufacturer may use a product registration return card, an e-mail contact, or other means to obtain owner identification information. Typical owner identification information will include the owner's name and a contact point for the owner, whether this is a mailing address, a telephone number, an e-mail address, or a combination of these. The manufacturer will typically compile and maintain this owner identification information in a database that it will maintain, for future marketing efforts, as a past buyer of the goods. The database will therefore comprise a population of records, each record making a one-to-to correspondence between a unique identifying signal associated with an object and a set of identifying information of the owner, having at least the owner name and a contact point. In one embodiment, the manufacturer of an item may wish to make itself available as a service provider for a finder of the item, so that when an item is found and the finder contacts that manufacturer, a conduit through which the item can be returned to the owner is established. In this sort of instance, the manufacturer is the de facto repatriation organization or service provider.

In other instances, the manufacturer may not wish to interject itself into the repatriation process. However, the manufacturer may be willing to provide owner information, when received from an owner registering the product with the manufacturer, along with the unique identifying signal associated with the individual item, to a repatriation organization providing that service.

In either of these circumstances, the manufacturer's trademarks and/or trade dress that are applied to the item may well serve as the visibly discernable indicia by which an item covered by the repatriation organization may be determined. By definition, trademarks and trade dress serve to identify an affiliation of the item with the manufacturer. If the manufacturer participates in advertising and/or other promotional efforts that associate it with the repatriation organization, this advertising or promotional effort may result in increased sale value of the item, if the repatriation services are perceived as being of value. With many items, this will be the result.

Beyond any unique identifying signal transponders 26 that may be placed by a manufacturer, there are many instances when a product may be identified by an owner as a item that should be associated with a unique identifying signal, but which may have been manufactured without a transponder being installed. As an illustrative example, a piece of jewelry received as a gift, especially from a spouse, parent or child, may have particular sentimental value far exceeding its inherent value. In such a case, the transponder 26 may be affixed externally to the personal property item, especially by a repatriation organization at the time that the owner enrolls with the repatriation organization. In such a situation, it will be a visibly discernable indicium 28 of the repatriation organization that will be used to attract the attention of a finder. While the natural inclination may be to include both the transponder 26 and the visibly discernable indicium 28 in a tag 40 or the like that is associated with the item, for instance in a luggage tag, it may be somewhat counterproductive to this, as such a tag may be so readily identifiable as to be the first thing a thief will remove from the item after coming into possession.

An example of this is shown in FIG. 3, where a piece of luggage 300, not bearing a manufacturer-supplied transponder, has had a transponder 26 affixed to it by the owner, although in a rather concealed manner. A tag 40, bearing a visibly discernable indicium 28 of a repatriation organization, is also attached to the item. A finder, seeing the tag 40 and recognizing the indicium 28, will realize that the item may be able to be repatriated, and will either contact the repatriation organization or will scan the item to obtain the unique identification code. However, mere removal of the tag 40 will not inherently remove the transponder 26, so a thief who removes the tag will not render the item unable to be repatriated through the repatriation organization.

At this point, then, the repatriation method can be described. For purposes of the description, a repatriation organization that is independent of any specific manufacturer will be presumed. Because the items that will be able to be repatriated through an independent organization such as this will vary so drastically in type, it may be important for the repatriation organization to have a marking that operates as the visibly discernable indicium indicating the affiliation of the item with the repatriation organization. In one embodiment, the distinctive marking feature will comprise a telephone number of the repatriation organization, and preferably a toll-free telephone number. In another embodiment, the distinctive marking feature will comprise a URL for the internet, such as, for exemplary purposes only, www.finderskeepers.com. In a third embodiment, the distinctive marking feature will comprise a uniquely shaped or colored device that identifies source in a trademark sense. In any or all of these embodiments, and in particular with the third embodiment, a person who finds an object having the distinctive marking feature will be able to identify the object as an object that is covered by a repatriation service provided by the repatriation organization.

The visibly discernable indicium used by a repatriation organization does not need to remain the same over time. In early embodiments of the invention, the repatriation organization will not be well known, so early embodiments will probably use at least a phone number or web address as a part of the distinctive marking feature, along with the name of the organization. As use of the repatriation system increases, a simpler (and hence smaller) marking feature may be used. To enable this, the repatriation organization will use “look for” advertising that associates it with the distinctive marking feature.

It will also be recognized that RFID technology is developing, such that different types of transponders will use different frequency bands or ranges for emitting the unique identifying signal. Because of this, a repatriation system that does not look for a signal in each of the frequency ranges may easily overlook an otherwise identifiable item. In some embodiments, then, the visibly discernable indicium may provide information about the appropriate frequency band. As an example, the color of a logo used as part of the indicium may vary with frequency range of the RFID transponder with which it is associated, with red being used in association with a first band, blue with a second band, etc.

In a particularly preferred, but advanced, embodiment of the method, the visibly discernable indicium may become superfluous, as an expectation may arise, through the fame of the repatriation process, that a valuable item is associated with the repatriation process. Also, as devices for detecting and interpreting the unique identifying signals of the transponders become more widely disseminated to the “frequent finders,” lost items will be scanned to detect the identifying signals, regardless of whether the visibly discernable indicium is present. In fact, as a part of its service, a repatriation organization operating under the method of the invention may supply receiver devices for detecting the unique identifying signals from participating items to a variety of locations that may come into possession of lost items, the so-called “frequent finders.” Some examples include police departments, pawn shops, transportation terminals (airports, bus and train stations) and entertainment venues (stadiums, arenas, and the like).

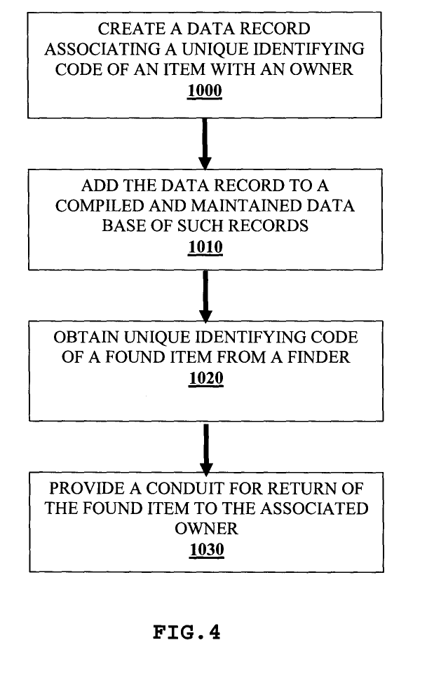

An exemplary repatriation system is shown in a flow diagram in FIG. 4. The system involves several steps. In a first step, identified as 1000, a data record is created that associates the unique identifying code of a transponder with an owner. The transponder has been associated with an item of personal property, by a manufacturer, by the owner, or by the repatriation organization. Various aspects of the association of the transponder with the item are described above. In this step, it is the creation of the association of the unique identifying code with the owner, and more particularly with the owner contact point, that is the characterizing feature. In some cases, the purchase price of an item may include a subscription fee for a fixed term of service with the repatriation organization. In other cases, a insurer of the personal property may provide the subscription to the repatriation organization as a part of the insurance policy, as the ability to repatriate found items may significantly reduce costs to the insurer on loss claims.

An owner of the item having the data record created in step 1000 will provide, at minimum, a name and a contact point for the owner. Optionally, the owner may also provide identifying information regarding the particular object, such as identifying it by characterizing features, including, for illustrative purposes, a serial number, as on a mobile telephone or other electronic device.

Data records created in step 1000 are added to a database that is compiled under step 1010, by the repatriation organization. This step will be well-known to those of skill in the computer database art.

To move from step 1010 to 1020, an item having a transponder with the unique identifying code must come into the possession of a “finder,” a term that is to be broadly understood. Generally, a “finder” is a person who finds an object capable of emitting a unique identifying code, recognizes that the object has value to the owner, and who also recognizes that the owner would not have left it unattended. The finder can contact the repatriation organization to obtain instructions on initiating repatriation proceedings.

The contact with the repatriation organization may occur in many different manners. As illustrative example only, a finder may send the item with the transponder still attached, to the repatriation organization, along with contact information on the finder, such as name, address, phone number or the like. In another situation, a “frequent finder” equipped with the ability to “read” the unique identifying signal, may simply read the signal and provide the code to the repatriation organization, while also including contact information for the finder. This latter type of contact may be done in writing, over a computer network, by telephone, or through many other means that will be known.

In any of these circumstances, the repatriation organization has obtained identifying code information from a finder, as in step 1020, and will attempt to match as many “found” items with data records contained in its database as possible.

Items that are found and which are linked to data records in the database will have a conduit for their return established, as in step 1030. In a typical business method, an item actually received by the repatriation organization will be returned to the owner, with the transponder device still attached. In another possible scenario, where the item is still possessed by the finder, an address to which the item should be sent or delivered will be provided. In most returns, the owner need never be directly identified to the finder, as the conduit for return passes through the repatriation organization.

In some circumstances, the repatriation organization may provide an appropriate reward to the finder, typically monetary, upon making the return.

Obvious advantages of the invention will be immediately recognized by one of ordinary skill in this art, but they include the opportunity for an owner of certain objects to lock out access to the device, without fear of precluding return of the device if it is lost. For example, an owner of a mobile phone may be somewhat reluctant to use a “lock out” feature on the phone, for fear that a finder would not even be able to identify the phone number of the mobile phone. However, the same owner, especially in the case of a celebrity, may be similarly reluctant to not use the lock out feature, so that unlisted phone numbers of friends and associates would not be revealed in case of loss. By using a system of the pesent invention incorporated into the housing of the mobile phone, a finder would be able to identify the phone as an object protected by a contract with the repatriation organization. The phone could be returned without even the repatriation organization being able to access the private phone numbers. In another example, the loser of a set of car keys could have his keys returned without a fear of having his car stolen by the finder.

In some other embodiments of the invention, the inventive method will allow stolen goods to be repatriated with their owners. Such stolen goods, when recovered in the possession of a thief, will serve to establish that the thief has no right to possess the goods. In some instances, a victim of a theft will contact the repatriation organization, so that any repatriation attempt may be investigated to see if the “finder” has rightfully come into possession of the object, before any reward is paid.

What is claimed is:

1. An arrangement for repatriating an item of lost personal property with an owner thereof, comprising:
a transponder closely associated with the personal property item, the transponder emitting a unique identifying signal when stimulated by an excitation signal; and
a database, comprising a population of records, each record associating the unique identifying signal from one of the transponders with identifying information of the owner of the personal property item associated with the transponder, the database maintained by a service provider;
such that when finder of the item contacts the service provider, a conduit through which the item can be returned to the owner is established.

2. The arrangement of claim 1, wherein:
the transponder is a radio frequency identification (“RFID”) transponder.

3. The arrangement of claim 2, wherein:
the transponder is internally contained within the personal property item.

4. The arrangement of claim 1, wherein:
the transponder is internally contained within the personal property item.

5. The arrangement of claim 2, wherein:
the transponder is affixed externally to the personal property item.

6. The arrangement of claim 1, wherein:
the transponder is affixed externally to the personal property item.

7. The arrangement of claim 3, further comprising:
a visibly discernable indicium associated with the personal property item, the indicium identifying an affiliation with the service provider.

8. The arrangement of claim 5, further comprising:
a visibly discernable indicium associated with the personal property item, the indicium identifying an affiliation with the service provider.

9. The arrangement of claim 1, further comprising:
a visibly discernable indicium associated with the personal property item, the indicium identifying an affiliation with the service provider.

10. The arrangement of claim 1, further comprising:
a means for emitting an excitation signal and receiving the unique identifying signal from transponder located proximately thereto, for use by the owner to locate misplaced items.

11. A method for repatriating an item of lost personal property with an owner thereof, comprising the steps:
associating at least one item of the owner's personal property with the owner by establishing a one-to-one relationship between the owner and a unique identifying signal emitted by the personal property item when a transponder associated with the item is stimulated by an excitation signal; and
compiling and maintaining a database, comprising a population of records, each record associating the unique identifying signal from one of the transponders with identifying information of the owner of the personal property item associated with the transponder;
providing a service of at least one means through which a finder of the lost item can establish a conduit for the return of the item to the owner.

12. The method of claim 11, wherein:
the associating step comprises the substep of either: identifying the unique identifying signal of the transponder, which is internally contained within the personal property item, or associating the unique identifying signal with the item by affixing the transponder to the item.

13. The method of claim 12, wherein:
the associating step further comprises the substep of affixing a visibly discernable indicium on the personal property item, the indicium identifying an affiliation with the service provider.

14. The method of claim 11, wherein:
the associating step further comprises the substep of affixing a visibly discernable indicium on the personal property item, the indicium identifying an affiliation with the service provider.

15. The method of claim 11, wherein:
the contact providing step comprises the steps of: receiving information about the unique identifying signal from the signal, and repatriating the item with the owner when the owner is identifiable.

16. The method of claim 15, wherein:
the repatriating step includes the step of paying an appropriate reward to the finder.
